(19) United States
(12) Patent Application Publication
(10) Pub. No.: US 2024/0240112 A1
(43) Pub. Date: Jul. 18, 2024

(54) LIQUID HAND DISHWASHING DETERGENT COMPOSITION

(71) Applicant: The Procter & Gamble Company, Cincinnati, OH (US)

(72) Inventors: Karl Ghislain BRAECKMAN, Gerpinnes (BE); Kelly Paula August MERCKX, Kersenweg (BE); Pieter Jan Maria SAVEYN, Heusden (BE); Evelyne Johanna Lutgarde VAN HECKE, Bachte - Maria- Leerne (BE); Robby Renilde François KEULEERS, Lippelo (BE)

(21) Appl. No.: 18/407,493

(22) Filed: Jan. 9, 2024

(30) Foreign Application Priority Data
Jan. 13, 2023 (EP) 23151448.0
Jan. 13, 2023 (EP) 23151453.0
Oct. 9, 2023 (EP) 23202394.5
Oct. 9, 2023 (EP) 23202400.0

(51) Int. Cl. C11D 1/00; C11D 1/29; C11D 1/65; C11D 1/94

(52) U.S. Cl. CPC C11D 1/008; C11D 1/29; C11D 1/65; C11D 1/94; C11D 2111/14

(57) ABSTRACT

A liquid hand dishwashing detergent composition includes a quaternised acrylic copolymer, and from 5.0% to 50% by weight of the liquid hand dishwashing detergent composition of a surfactant system. The surfactant system includes anionic surfactant; and co-surfactant selected from the group consisting of amphoteric surfactant, zwitterionic surfactant, and mixtures thereof. The anionic surfactant and co-surfactant are present in a weight ratio of less than about 1.5:1.

### TECHNICAL FIELD

The present disclosure relates to liquid hand dishwashing detergent compositions, which comprise quaternised acrylic copolymers and provide further improved drying times for the dishware after rinsing.

### BACKGROUND

Manual dishwashing is a time-consuming task which is considered by many who do it to be complete when they can put their dishware away. As such, fast drying of dishware after dishwashing and rinsing is highly desired. Drying is particularly affected by the water hardness, with reduced sheeting of the water off dishware with water having lower hardness. With the greater prevalence of in-home water-softeners, there remains a greater need for improving sheeting and hence drying speed.

The use of quaternised acrylic copolymers for improving the speed of drying is known. Such copolymers increase the speed of drying by improving the sheeting of water off the dishware and improving beading of the water.

However, it has been found that the performance of such copolymers in liquid detergent compositions, which do not comprise an alkoxylated alcohol nonionic surfactant, has been relatively poor, especially under soft water conditions. As such, there remains a need to further improve the drying time after the manual washing of dishware, without the need to formulate using high levels of alkoxylated alcohol nonionic surfactant.

WO201836864A relates to hard surface treatment compositions comprising quaternised acrylic copolymer and amphoteric modified polysaccharide, wherein the weight ratio of the quaternised acrylic copolymer to the amphoteric modified polysaccharide is from 0.75:1 to 3:1 and the quaternised acrylic copolymer is different from the amphoteric modified polysaccharide. EP3835399A1 relates to hard surface cleaning composition comprising a surfactant system; a first polymer; and a second polymer, the first polymer being a polyethyleneimine, as well as to the use of the composition to clean a glass surfaces. US20030134770A relates to liquid detergent compositions comprising a polymeric material which is a suds enhancer and a suds volume extender, said compositions having increased effectiveness for preventing re-deposition of grease during hand washing, the polymeric material being suitable as suds volume and suds endurance enhancers and comprising an effective amount of a quaternary nitrogen-containing monomeric unit and/or zwitterionic monomeric unit-containing polymeric suds enhancer. EP3835399A1 relates to a hard surface cleaning composition comprising a surfactant system; a first polymer; and a second polymer, the first polymer being a polyethyleneimine.

### SUMMARY

The present disclosure relates to liquid hand dishwashing detergent composition comprising a quaternised acrylic copolymer, and from 5.0% to 50% by weight of the liquid hand dishwashing detergent composition of a surfactant system, wherein the surfactant system comprises: anionic surfactant; and co-surfactant selected from the group consisting of: amphoteric surfactant, zwitterionic surfactant, and mixtures thereof; wherein the anionic surfactant and co-surfactant are present in a weight ratio of less than 1.5:1.

### DETAILED DESCRIPTION

Formulating the liquid cleaning composition with the surfactant system, as described herein, in addition to a quaternised acrylic copolymer can be used improve the speed of drying of dishware after hand dishwashing.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the present disclosure described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes initial suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high initial suds volume and/or sustained suds volume, particularly during a substantial portion of or for the entire manual dishwashing process. This is important as the consumer uses high suds as an indicator that enough cleaning composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' present disclosures as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Cleaning Composition

The cleaning composition is a liquid cleaning composition, preferably a liquid hand dishwashing cleaning composition, and hence is in liquid form. The liquid cleaning composition is preferably an aqueous cleaning composition. As such, the composition can comprise from 50% to 85%, preferably from 50% to 75%, by weight of the total composition of water.

The liquid cleaning composition has a pH greater than 6.0, or a pH of from 6.0 to 12.0, preferably from 7.0 to 11.0, more preferably from 7.5 to 10.0, measured as a 10% aqueous solution in demineralized water at 20 degrees ° C.

The liquid cleaning composition of the present disclosure can be Newtonian or non-Newtonian, preferably Newtonian. Preferably, the composition has a viscosity of from 10 mPa's to 10,000 mPa·s, preferably from 100 mPa's to 5,000 mPa·s, more preferably from 300 mPa's to 2,000 mPa·s, or most preferably from 500 mPa·s to 1,500 mPa·s, alternatively combinations thereof. The viscosity is measured at 20° ° C. with a Brookfield RT Viscometer using spindle 31 with the RPM of the viscometer adjusted to achieve a torque of between 40% and 60%.

### Quaternised Acrylic Copolymer

The liquid hand dishwashing detergent comprises a quaternised acrylic copolymer. “Copolymer” as used herein refers to a polymer comprising at least two different monomer compositions. Quaternised polymers comprise quaternary ammonium groups, which are positively charged polyatomic ions of the structure NR₄⁺, R being an alkyl group or an aryl group. Unlike the ammonium ion (NH₄⁺) and the primary, secondary, or tertiary ammonium cations, the quaternary ammonium cations are permanently charged, independent of the pH of their solution.

The composition preferably comprises from 0.01% to 3.0%, preferably from 0.05% to 2.0%, more preferably from 0.1% to 1.0% by weight of the composition of the quaternised acrylic copolymer.

The quaternised acrylic copolymer can have a weight average molecular weight (Mw), measured by aqueous gel permeation chromatography (GPC) with light scattering detection (SEC-MALLS), in the range of from 5,000 to 500,000 Da, preferably from 15,000 to 300,000 Da and even more preferably from 25,000 to 75,000 Da.

The quaternised acrylic copolymer may be characterized by a cationic charge density. Cationic charge density is typically expressed as milliequivalents of charge per gram of compound (mEq/g). The hydrophobically modified cationic polyvinyl alcohols of the present disclosure may be characterized by a cationic charge density (or “CCD”) ranging from 0.10 mEq/g to 4.0 mEq/g, preferably from 1.0 mEq/g to 3.50 mEq/g, more preferably from 1.75 mEq/g to 2.75 mEq/g.

Preferably the different types of monomer units are randomly distributed over the quaternised acrylic copolymer.

The quaternised acrylic copolymer is preferably derived from cationic monomer units and ethylenically unsaturated monomer units.

The cationic monomer units can be selected from:

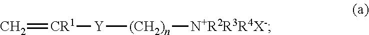

wherein:
each R¹ are independently selected from a hydrogen or a methyl, preferably a methyl;
each R² is independently selected from a C1 to C4 alkyl(ene), preferably CH₂CH═CH₂ or methyl, more preferably methyl;
each R³, R⁴ are independently selected from a C1 to C4 alkyl, preferably C1 to C3 alkyl, more preferably methyl;
each Y is a linking group independently selected from: CO—NR⁵—(CH₂)ₙ, CO—O—(CH₂)ₙ, or (CH₂)ₙ, preferably CO—NR⁵—(CH₂)ₙ, or (CH₂)ₙ, more preferably CO—NR⁵—(CH₂)ₙ,
wherein:
   each R⁵ is independently selected from hydrogen or methyl, preferably hydrogen,
   n is an average of from 1 to 4, preferably 1 or 3, more preferably 3; and
X⁻ is a suitable counterion, preferably X is independently selected from a halide counterion, more preferably Cl⁻.

The choice of linking group Y is dependent on the reaction scheme used to make the quaternised acrylic copolymer. Preferably, all Y are the same. Preferably, all R⁵ are the same.

The cationic monomer units can be selected from the group consisting of: acrylamidopropyl trimethylammonium chloride (APTAC), methacrylamidopropyltrimethylammonium chloride (MAPTAC), diallyl dimethyl ammonium chloride (DADMAC), acryloyloxyethyltrimethylammonium chloride (AETAC), methyloyloxyethyltrimethyl ammonium chloride (METAC), and mixtures thereof. Particularly preferred cationic monomers are (meth)acrylamidopropyltrimethylammonium chloride (APTAC or MAPTAC) or diallyldimethylammonium chloride (DADMAC), with methacrylamidopropyltrimethylammonium chloride (MAPTAC) being most preferred. Two polymeric structures are possible when polymerizing DADMAC: N-substituted piperidine structure or N-substituted pyrrolidine structure. The pyrrolidine structure is favored (see John, Wilson; et al. (2002), Synthesis and Use of PolyDADMAC for Water Purification).

The ethylenically unsaturated monomers can be selected from the group consisting of: C3-C8 ethylenically unsaturated acids and/or salts thereof, C3-C8 hydroxyalkyl acrylates, and mixtures thereof. By C3-C8, it is meant that the ethylenically unsaturated acids and/or salts thereof, or C3-C8 hydroxyalkyl acrylate comprises from 3 to 8 carbon atoms.

Suitable C3-C8 ethylenically unsaturated acids and/or salts thereof include (meth)acrylic acid and mixtures thereof, with acrylic acid being preferred. Suitable salts include alkali metal and ammonium salts.

Suitable C3-C8 hydroxyalkyl acrylates can be selected from the group consisting of: ethyl (meth)acrylate, 2-hydroxyethyl (meth)acrylate, 2-hydroxy-2-methylethyl (meth)acrylate, 2-hydroxy-1-methylethyl (meth)acrylate, and mixtures thereof, preferably ethyl (meth)acrylate, 2-hydroxyethyl (meth)acrylate, and mixtures thereof, more preferably ethyl (meth)acrylate, with ethyl acrylate being most preferred.

The quaternised acrylic copolymer can further comprise additional monomers selected from the group consisting of: ethyl acrylate, 2-acrylamido-2-methylpropane-sulfonic acid, N-isopropylamide, vinylpyrrolidone, and mixtures thereof, as polymerized monomers, with ethyl acrylate and/or vinylpyrrolidone being preferred, with ethyl acrylate being particularly preferred.

The additional monomer is preferably present at a level of less than 20 mol %, preferably less than 15 mol %, more preferably less than 10% of the total monomers present in the quaternised acrylic.

The quaternised acrylic copolymer can comprise diallyldimethylammonium chloride (DADMAC) as the cationic monomer with hydroxyethylacrylate as the ethylenically unsaturated monomer. Such quaternised acrylic copolymers can comprise vinylpyrrolidone as an additional monomer. Such quaternised acrylic copolymers include those sold under the tradename of Mirapol® SURF-S FAST DRY by Solvay.

More preferably, the quaternised acrylic copolymer can comprise (meth)acrylamidopropyltrimethylammonium chloride (APTAC or MAPTAC) as the cationic monomer, with acrylate and/or ethyl acrylate as the ethylenically unsaturated monomer. Such quaternised acrylic copolymers can comprise ethyl acrylate as an additional monomer. Such quaternised acrylic copolymers include those sold under the tradename of Polyquart® by BASF, with Polyquart149A® being particularly preferred.

### Surfactant System

The liquid cleaning composition comprises from 5.0% to 50%, preferably from 6.0% to 40%, most preferably from 15% to 35%, by weight of the total composition of a surfactant system. The surfactant system comprises an anionic surfactant and a co-surfactant selected from amphoteric surfactant, zwitterionic surfactant, or mixtures thereof.

The anionic surfactant and co-surfactant are present in a weight ratio of less than 1.5:1, preferably from 0.5:1 to 1.5:1, more preferably from 0.8:1 to 1.2:1.

### Anionic Surfactant

The surfactant system comprises an anionic surfactant. The surfactant system can comprise at least 35%, preferably from 35% to 65%, more preferably from 40% to 60% by weight of the surfactant system of an anionic surfactant. The surfactant system is preferably free of fatty acid or salt thereof, since such fatty acids impede the generation of suds.

Suitable anionic surfactants can be selected from the group consisting of: alkyl sulphated surfactant, alkyl sulphonated surfactant, alkyl sulphosuccinate and dialkyl sulphosuccinate ester surfactants, and mixtures thereof.

The anionic surfactant can comprise at least 70%, preferably at least 85%, more preferably 100% by weight of the anionic surfactant of alkyl sulphated anionic surfactant.

The mol average alkyl chain length of the alkyl sulphated anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulphated anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulphated anionic surfactant can be derived from the carbon chain length distribution of the anionic surfactant. The carbon chain length distribution of the alkyl chains of the alkyl sulphated anionic surfactants can be obtained from the technical data sheets from the suppliers for the surfactant or constituent alkyl alcohol. Alternatively, the chain length distribution and average molecular weight of the fatty alcohols, used to make the alkyl sulphated anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulphated anionic surfactant should be hydrolysed back to the corresponding alkyl alcohol and alkyl alkoxylated alcohol before analysis, for instance using hydrochloric acid.

The alkyl sulphated anionic surfactant can be alkoxylated or free of alkoxylation. When alkoxylated, the alkyl sulphated anionic surfactant can have an average degree of alkoxylation of less than 3.5, preferably from 0.3 to 2.0, more preferably from 0.5 to 0.9, in order to improve low temperature physical stability and improve suds mileage of the compositions of the present disclosure. When alkoxylated, ethoxylation is preferred.

The average degree of alkoxylation is the mol average degree of alkoxylation (i.e., mol average alkoxylation degree) of all the alkyl sulphated anionic surfactant. Hence, when calculating the mol average alkoxylation degree, the mols of non-alkoxylated alkyl sulphate anionic surfactant are included:

Mol average alkoxylation degree=(x1*alkoxylation degree of surfactant 1+x2*alkoxylation degree of surfactant 2+ . . . )/(x1+x2+ . . . )
wherein x1, x2, . . . are the number of moles of each alkyl (or alkoxy) sulphate anionic surfactant of the mixture and alkoxylation degree is the number of alkoxy groups in each alkyl sulphated anionic surfactant.

Preferred alkyl alkoxy sulphates are alkyl ethoxy sulphates.

The alkyl sulphated anionic surfactant can have a weight average degree of branching of at least 10%, preferably from 20% to 60%, more preferably from 25% to 45%.

The alkyl sulphated anionic surfactant can comprise at least 5%, preferably at least 10%, most preferably at least 25%, by weight of the alkyl sulphated anionic surfactant, of branching on the C2 position (as measured counting carbon atoms from the sulphate group for non-alkoxylated alkyl sulphate anionic surfactants, and the counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphated anionic surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the liquid cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+×2*wt % branched alcohol 2 in alcohol 2+ . . . )/(x1+x2+ . . . )]*100
wherein x1, x2, . . . are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulphated anionic surfactant.

Suitable counterions include alkali metal cation earth alkali metal cation, alkanolammonium or ammonium or substituted ammonium, but preferably sodium.

Suitable examples of commercially available alkyl sulphated anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulphate anionic surfactant, including grease cleaning, sudsing, low temperature stability and viscosity of the finished product. The alkoxylation distribution, including its broadness can be varied through the selection of catalyst and process conditions when making the alkoxylated alkyl sulphate anionic surfactant.

If ethoxylated alkyl sulphate is present, without wishing to be bound by theory, through tight control of processing conditions and feedstock material compositions, both during alkoxylation especially ethoxylation and sulphation steps, the amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulphates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Anionic alkyl sulphonate or sulphonic acid surfactants suitable for use herein include the acid and salt forms of alkylbenzene sulphonates, alkyl ester sulphonates, primary and secondary alkane sulphonates such as paraffin sulfonates, alfa or internal olefin sulphonates, alkyl sulphonated (poly)carboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates especially C5-C20 methyl ester sulfonates, C6-C22 primary or secondary alkane sulphonates, C5-C20 sulphonated (poly)carboxylic acids, and any mixtures thereof, but preferably C11-C13 alkylbenzene sulphonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulphonates include paraffin sulphonates and other secondary alkane sulfonate (such as Hostapur SAS60 from Clariant).

Alkyl sulfosuccinate and dialkyl sulfosuccinate esters are organic compounds with the formula MO3SCH(CO2R′)CH2CO2R where R and R′can be H or alkyl groups, and M is a counterion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulphated anionic surfactant.

### Co-Surfactant

In order to improve surfactant packing after dilution and hence improve suds mileage, the surfactant system can comprise a co-surfactant. The co-surfactant can be selected from the group consisting of an amphoteric surfactant, a zwitterionic surfactant and mixtures thereof.

The composition preferably comprises from 1.0% to 30%, more preferably from 5.0% to 25% and especially from 10% to 20% by weight of the cleaning composition of the co-surfactant.

The surfactant system of the cleaning composition of the present disclosure preferably comprises up to 65%, preferably from 30% to 65%, more preferably from 40% to 60%, by weight of the surfactant system of a co-surfactant.

The co-surfactant is preferably an amphoteric surfactant, more preferably an amine oxide surfactant.

The amine oxide surfactant can be linear or branched, though linear are preferred. Suitable linear amine oxides are typically water-soluble, and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxyethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the present disclosure can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine, and preferably meets formula (I):

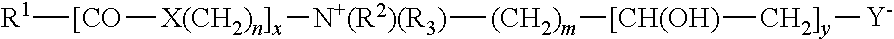

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaine of formula (Ic) and the amido sulphobetaine of formula (Id):

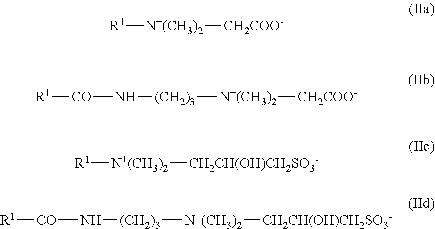

in which R1 has the same meaning as in formula (I). Particularly preferred are the carbobetaines [i.e. wherein Y—═COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant:

The surfactant system can further comprises less than 3.0% by weight of the composition of alkoxylated alcohol nonionic surfactant. If present, the surfactant system preferably comprises at least 0.5%, preferably at least 1.0% more preferably at least 2.0% by weight of the composition of the alkoxylated alcohol nonionic surfactant. Alternatively the composition can comprise greater than 3.0%, preferably from 3.5% to 10%, more preferably from 4.0% to 7.5% by weight of the liquid hand dishwashing detergent composition of an alkoxylated alcohol nonionic surfactant.

The anionic surfactant and alkoxylated alcohol nonionic surfactant can be present in a weight ratio of less than 10:1. The anionic surfactant and alkoxylated alcohol nonionic surfactant are preferably present in a weight ratio of from 0.8:1 to 6.0:1, more preferably from 3.5:1 to 5.5:1.

The surfactant system of the liquid hand dishwashing detergent composition can comprise at least 5%, preferably from 5% to 35%, more preferably from 10% to 30%, by weight of the surfactant system of the alkoxylated alcohol nonionic surfactant.

Preferably, the alkoxylated alcohol non-ionic surfactant is a linear or branched, preferably linear, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of alkylene oxide per mole of alcohol. The alkoxylated alcohol non-ionic surfactant is preferably ethoxylated and/or propoxylated, more preferably ethoxylated.

The surfactant system can comprise a further nonionic surfactant such as an alkyl polyglucoside nonionic surfactant:

A combination of alkylpolyglucoside and anionic surfactant especially alkyl sulfate anionic surfactant, has been found to improve polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

If present, the alkyl polyglucoside can be present in the surfactant system at a level of from 0.5% to 20%, preferably from 0.75% to 15%, more preferably from 1% to 10%, most preferably from 1% to 5% by weight of the surfactant composition. Alkyl polyglucoside nonionic surfactants are typically more sudsing than other nonionic surfactants such as alkyl ethoxylated alcohols.

In other preferred compositions, the alkyl polyglucoside is present at a level of less than 2.0%, preferably less than 1.0%, more preferably less than 0.5% by weight of the composition.

In even more preferred compositions, the composition is free of any further nonionic surfactant.

### Further Ingredients:

The composition can comprise further ingredients such as those selected from: amphiphilic alkoxylated polyalkyleneimines, cyclic polyamines, triblock copolymers, hydrotropes, organic solvents, other adjunct ingredients such as those described herein, and mixtures thereof.

### Amphiphilic Alkoxylated Polyalkyleneimine:

The composition of the present disclosure may further comprise from 0.05% to 2%, preferably from 0.07% to 1% by weight of the total composition of an amphiphilic polymer.

Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

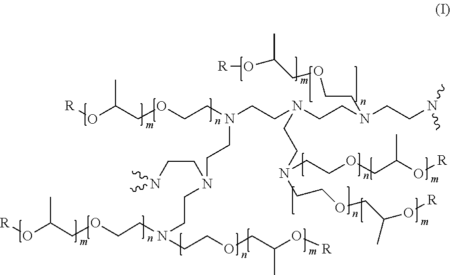

wherein the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the compositions can be free of amphiphilic polymers.

### Cyclic Polyamine

The composition can comprise a cyclic polyamine having amine functionalities that helps cleaning. The composition of the present disclosure preferably comprises from 0.1% to 3%, more preferably from 0.2% to 2%, and especially from 0.5% to 1%, by weight of the total composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present disclosure are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulphate is particularly preferred. As such, the composition can further comprise magnesium sulphate at a level of from 0.001% to 2.0%, preferably from 0.005% to 1.0%, more preferably from 0.01% to 0.5% by weight of the composition.

### Triblock Copolymer

The composition of the present disclosure can comprise a triblock copolymer. The triblock co-polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present disclosure may further comprise at least one active selected from the group consisting of: i) a salt, ii) a hydrotrope, iii) an organic solvent, and mixtures thereof.

### Salt:

The composition of the present disclosure may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

### Hydrotrope:

The composition of the present disclosure may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

### Organic Solvent:

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm² to 20 mm², preferably from 3.8 mm² to 12 mm², more preferably from 5 mm² to 10 mm², wherein the container further comprises the composition according to the present disclosure. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### Method of Washing

The present disclosure is further directed to a method of manually washing dishware with the composition of the present disclosure. The method comprises the steps of delivering a composition of the present disclosure to a volume of water to form a wash solution and immersing the dishware in the solution. The dishware is be cleaned with the composition in the presence of water.

Optionally, the dishware can be rinsed. By “rinsing”, it is meant herein contacting the dishware cleaned with the process according to the present disclosure with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the cleaning composition, preferably in liquid form, of the present disclosure diluted in water. The actual amount of cleaning composition used will be based on the judgment of the user and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the present disclosure is combined with from about 2,000 mL to about 20,000 mL, more typically from about 5,000 mL to about 15,000 mL of water in a sink. The soiled dishware are immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

### Methods

### A) Molecular Weight Determination by Gel Permeation Chromatography:

Gel Permeation Chromatography (GPC) with Multi-Angle Light Scattering (MALS) and Refractive Index (RI) Detection (GPC-MALS/RI) is a well known system to directly measure the weight average molecular weight, M_{w}, and number average molecular weight, Mₙ, of a polymer without the need for comparisons with known reference standards.

The true number-average molecular weight, Mₙ, of polymers can be obtained by GPC coupled with light-scattering detection and refractive index detection even if the composition and therefore the refractive index increment varies with elution volume, provided slices taken are sufficiently monodisperse with respect to molecular weight and composition.

For example, the molecular weight distribution of polymer can be measured using a Liquid Chromatography system such as an Agilent 1260 Infinity pump system with OpenLab Chemstation software (from Agilent Technology, Santa Clara, CA, USA) provided with two ultrahydrogel linear columns, 7.8 mm ID×300 mm length used in series (S/N 002C180181 VE077 and 005C180181 VE084, supplied by Waters Corporation of Milford, Mass., USA) and an ultrahydrogel guard column (6 mm ID×40 mm length, S/N2016260401BE105, also supplied Waters Corporation of Milford, Mass., USA) installed between the injector and the analytical column to prevent any impurities and suspended solids from reaching the analytical column, operated at 40° C. A multiangle light scattering (MALS) detector DAWN® and a differential refractive index (RI) detector (Wyatt Technology of Santa Barbara, Calif., USA) controlled by Wyatt Astra® software can be used for the detection.

Since the analytes are spread over a relatively narrow time window, an isocratic rather than gradient elution method can be used. Isocratic means that the mixture of your mobile phase is consistent over the complete testing time. Using a gradient implies that the compounding of the eluent mixture is changed during measurement and so influences the retention of analytes. The separation can be either accelerated or decelerated when using a gradient method.

0.1M sodium nitrate in water containing 0.02% sodium azide is used as the mobile phase. Samples are prepared by dissolving the polymer in the mobile phase at ˜1.0 mg per ml and by mixing the solution overnight at room temperature to ensure full hydration of the polymer. The sample is then filtered through a 0.8 μm Versapor membrane filter (AP4189, supplied by PALL, Life Sciences, NY, USA) into the LC autosampler vial using a 3-ml syringe. The sample is then pumped into the columns at a flow rate of 1.0 ml/min.

The number average and weight average molecular weights of the polymer are calculated from the dn/dc (differential change of refractive index with concentration) measurements, as provided by the Astra detector software.

### B) Water-Sheeting:

The speed of drying is related to the degree of water-sheeting. The higher the water-sheeting, the less water retained on the wet article.

The water sheeting behaviour is evaluated by washing grey ceramic plates (“Dinera” plates, 26 cm diameter, sourced form IKEA) with the hand dishwashing detergent test compositions, followed by scoring the amount of water sheeting observed on the plate when leaving them vertically on a drying rack. More particularly:

A sponge (Scotch-Brite® Classic-schuurspons van cellulose—supplied by 3M Belgium-dimension: 7 cm*10 cm) is homogeneously wetted with water of hardness 0.36 mmol/l CaCO₃ equivalence, at 25° C., by saturating the sponge with water, and subsequently manually squeezing until no further water is squeezed out).

1 ml of the hand dishwashing composition is homogeneously distributed over the sponge. The sponge is manually squeezed with full force 4 times above the ceramic plate using one hand to create foam, followed by washing the plate in 10 circular clockwise motions covering the edges as well as the center part of the plate, so that the full plate is treated with the foam.

The plate is then rinsed for 30 seconds under a running tap (25° C. water of having the same water hardness as before (0.36 mmol/l CaCO₃ equivalence) at a sufficient flow rate to enable full foam removal and full coverage with water after which the plate is placed vertically on a drying rack under standard room conditions (20+/−1° C.).

The water running down the plate is then visually evaluated and a score of between 0-100% is given depending on the amount of water that has run down the plate in the first 30 see, and therefore leaving an area of the plate already dry. 0% corresponds to water remaining on the full plate, 50% indicates that the half of the plate is covered with a film of water, and 100% indicating that no water film is visibly present.

### Examples

The following compositions were prepared and evaluated for their water-sheeting behaviour, using the method described herein. Rapid water-sheeting is an indicator of quick drying after rinsing.

In the compositions of Table 1, inventive example 1 comprised both anionic surfactant and a co-surfactant in a weight ratio of 1:1, in addition to a quaternised acrylic copolymer. Comparative example A comprises the same surfactant system, but did not comprise a quaternised acrylic copolymer. By comparing the water-sheeting results of example 1 with that from example A, the improvement in water-sheeting from the addition of the quaternised acrylic copolymer into compositions comprising anionic surfactant and co-surfactant in the desired ratio can be seen. In contrast, from the water-sheeting results of comparative examples B to D, it can be seen that the water-sheeting benefit is substantially reduced when the anionic surfactant to co-surfactant ratio is above the desired range.

TABLE 1
Comparative and inventive liquid hand dishwashing detergent compositions:

| wt % (100% active basis) | Ex 1 | Ex A* | Ex B* | Ex C* | Ex D* |
|---|---|---|---|---|---|
| C1213AE0.6S (33.43% branching) | 14.00 | 14.00 | 18.67 | 27.00 | 22.62 |
| C12-14 dimethyl amine oxide | 14.00 | 14.00 | 9.33 | 7.00 | 5.38 |
| Anionic:co-surfactant surfactant ratio | 1:1 | 1:1 | 2:1 | 3:1 | 4.2:1 |
| NaCl | 0.8 | 0.8 | 0.8 | 0.8 | 0.8 |
| PPG (MW2000) | 0.45 | 0.45 | 0.45 | 0.45 | 0.45 |
| Ethanol | 4.0 | 4.0 | 4.0 | 4.0 | 4.0 |
| MIT preservative | 0.0075 | 0.0075 | 0.0075 | 0.0075 | 0.0075 |
| Phenoxyethanol | 0.11 | 0.11 | 0.11 | 0.11 | 0.11 |
| Acrylate/ethyl acrylate/ | 0.5 | — | 0.5 | 0.5 | 0.5 |
| methacrylamidopropyl trimethyl | | | | | |
| ammonium chloride copolymer¹ | | | | | |
| Water and minors (perfume, dye) | bal. | bal. | bal. | bal. | bal. |
| pH (10% solution in demi water) | 9.0 | 9.0 | 9.0 | 9.0 | 9.0 |
| Water sheeting % | 35 | 5 | 10 | 10 | 10 |

*Comparative
¹a quaternised acrylic copolymer of use in the present disclosure, sold under the tradename of Polyquart ® 149A, supplied by BASF

The following compositions were prepared and evaluated for suds mileage benefit in the presence of greasy soil, at a water hardness of 1.25 mmol/L equivalence of Ca, and wash water temperatures of 25° C. (inventive wash method) and 40° C. (comparative and reference wash method), as described herein.

Example 2 comprised both a quaternised acrylic copolymer and unalkoxylated alkyl sulfate anionic surfactant and hence was of the present disclosure. Example E was similar to example 2 but did not comprise a quaternised acrylic copolymer. Example F was similar to example 2 but comprised ethoxylated alkyl sulfate anionic surfactant instead of unalkoxylated alkyl sulfate anionic surfactant. Example F was similar to example 2 but comprised ethoxylated alkyl sulfate anionic surfactant instead of unalkoxylated alkyl sulfate anionic surfactant and did not comprise a quaternised acrylic copolymer. As such, examples D, E and F were comparative compositions.

For all the compositions, the resultant suds mileage in the presence of greasy soil is given in table 2.

TABLE 2
Comparative and inventive liquid hand dishwashing detergent compositions,
and resultant suds mileage in the presence of greasy soil

| wt % (100% active basis) | Ex 2 | Ex E* | Ex F* | Ex G* |
|---|---|---|---|---|
| C12-13 alkyl sulfate (18% branching)² | 20.7 | 20.7 | — | — |
| C12-13 alkyl EO2 sulfate (18% branching)³ | — | — | 20.7 | 20.7 |
| C12-14 dimethyl amine oxide | 6.9 | 6.9 | 6.9 | 6.9 |
| C9-11 EO8 nonionic surfactant⁴ | 0.8 | 0.8 | 0.8 | 0.8 |
| NaCl | 0.7 | 0.7 | 0.7 | 0.7 |
| PPG (MW2000) | 0.5 | 0.5 | 0.5 | 0.5 |
| Citric acid (pH trimming agent) | 0.82 | 0.73 | 0.26 | 0.20 |
| Alkoxylated polyethyleneimine⁵ | 0.5 | 0.5 | 0.5 | 0.5 |
| Ethanol (viscosity trimming agent) | — | — | 1.0 | 1.0 |
| MIT preservative | 0.0035 | 0.0075 | 0.0075 | 0.0075 |
| Phenoxyethanol | 0.08 | 0.08 | 0.08 | 0.08 |
| Acrylate/ethyl acrylate/methacrylamidopropyl | 0.5 | — | 0.5 | — |
| trimethyl ammonium chloride copolymer¹ | | | | |
| Water and minors (perfume, dye) | bal. | bal. | bal. | bal. |
| pH (10% solution in demi water) | 9.0 | 9.0 | 9.0 | 9.0 |
| Suds mileage | 138 | 130 | 104 | 101 |

*Comparative
²made by 25ulphating C12-13 alkyl alcohol, sold under the tradename of Neodol 23 ® and supplied by Shell
³made by 25ulphating ethoxylated C12-13 alkyl alcohol, sold under the tradename of Neodol 23-2 ® and supplied by Shell
⁴sold under the tradename of Neodol ®, supplied by Shell
⁵Polyethyleneimine with a PEI backbone having a weight average molecular weight of 600 g/mol and 24EO and 16PO units per alkoxylation chain, supplied by BASF

As can be seen from the results above, the presence of quaternised acrylic copolymer in compositions comprising alkyl ethoxylated sulfate anionic surfactant provides a negligible improvement in suds mileage in the presence of greasy soil (comparing the results from comparative example F to that of comparative example G), when washing dishware using water at cold temperatures relative to when washing dishware using water at warm temperatures.

By comparing the results from comparative example E with that of comparative example F, it can be seen that formulating the composition using unalkoxylated alkyl sulfate surfactant instead of ethoxylated alkyl sulfate, without the presence of quaternised acrylic copolymer, results in a surprising improvement in suds mileage during low temperature cleaning of dishware, even though ethoxylated alkyl sulfate surfactant containing compositions are typically more stable at low temperatures than similar compositions formulated using unalkoxylated alkyl sulfate anionic surfactant.

By comparing the results from example 2 with that from example E, it can be seen that formulating the composition with the quaternised acrylic copolymer on top of a surfactant system comprising unalkoxylated alkyl sulfate anionic surfactant results in a further improvement in suds mileage at decreased versus increased temperatures.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any present disclosure disclosed or claimed herein or that it alone, or in any combination with any other reference or references, teaches, suggests or discloses any such present disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this present disclosure.

What is claimed is:

1. A liquid hand dishwashing detergent composition comprising:
a quaternised acrylic copolymer, and
from 5.0% to 50% by weight of the liquid hand dishwashing detergent composition of a surfactant system, wherein:
the surfactant system comprises:
anionic surfactant, and
co-surfactant selected from the group consisting of: amphoteric surfactant, zwitterionic surfactant, and mixtures thereof; and
the anionic surfactant and co-surfactant are present in a weight ratio of less than about 1.5:1.

2. The composition according to claim 1, wherein the composition comprises from about 0.01% to about 3.0%, preferably from about 0.05% to about 2.0% by weight of the composition of the quaternised acrylic copolymer.

3. The composition according to claim 1, wherein the quaternised acrylic copolymer has a weight average molecular weight (Mw), measured by aqueous gel permeation chromatography (GPC) with light scattering detection (SEC-MALLS), in the range of from about 5,000 to about 500,000 Da.

4. The composition according to claim 3, wherein the quaternised acrylic copolymer has a weight average molecular weight (Mw), measured by aqueous gel permeation chromatography (GPC) with light scattering detection (SEC-MALLS), in the range of from about 25,000 to about 75,000 Da.

5. The composition according to claim 1, wherein the quaternised acrylic copolymer has an average cationic charge density of from about 0.01 to about 2.8 mEq/g.

6. The composition according to claim 1, wherein the quaternised acrylic copolymer is derived from:
a. cationic monomer units selected from: 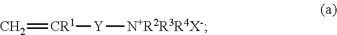
wherein:
each R¹ are independently selected from a hydrogen or a methyl;
each R² is independently selected from a C1 to C4 alkyl(ene);
each R³, R⁴ are independently selected from a C1 to C4 alkyl;
each Y is a linking group independently selected from: CO—NR⁵—(CH₂)ₙ, CO—O—(CH₂)ₙ, or (CH₂)ₙ,
wherein:
each R⁵ is independently selected from: hydrogen or methyl,
n is an average of from about 1 to about 4; and
X⁻ is a suitable counterion; and
b. ethylenically unsaturated monomer units.

7. The composition according to claim 6, wherein in the quaternised acrylic copolymer:
a. cationic monomer unit is selected from: 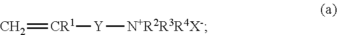
wherein:
each R¹ is methyl;
each R² is CH₂CH═CH₂ or methyl;
each R³, R⁴ are independently selected from a C1 to C3 alkyl;
each Y is a linking group independently selected from: CO—NR⁵—(CH₂)ₙ, or (CH₂)ₙ,
wherein:
each R⁵ is hydrogen,
n is an average of from about 1 or about 3.

8. The composition according to claim 6, wherein the cationic monomer unit is selected from the group consisting of: acrylamidopropyl trimethylammonium chloride (APTAC), diallyl dimethyl ammonium chloride (DADMAC); acryloyloxyethyltrimethylammonium chloride (AETAC); methacrylamidopropyltrimethylammonium chloride (MAPTAC); methyloyloxy ethyl trimethyl ammonium chloride (METAC), and mixtures thereof.

9. The composition according to claim 6, wherein the ethylenically unsaturated monomer units are selected from the group consisting of: C3-C8 ethylenically unsaturated acids and/or salts thereof, C3-C8 hydroxyalkyl acrylates, and mixtures thereof.

10. The composition according to claim 1, wherein the co-surfactant comprises an amphoteric surfactant, which is an amine oxide surfactant.

11. A liquid hand dishwashing cleaning composition comprising:
from 6% to 50% by weight of the total composition of a surfactant system, and a quaternised acrylic copolymer, wherein:
the surfactant system comprises at least 40% by weight of the surfactant system of anionic surfactant,
the anionic surfactant comprises at least 50% by weight of the anionic surfactant of alkyl sulfated anionic surfactant, and
the alkyl sulfated anionic surfactant has an average degree of alkoxylation of less than 0.1.

12. The composition according to claim 11, wherein the quaternised acrylic copolymer has a weight average molecular weight (Mw), measured by aqueous gel permeation chromatography (GPC) with light scattering detection (SEC-MALLS), in the range of from about 5,000 to about 500,000 Da.

13. The composition according to claim 11, wherein the quaternised acrylic copolymer has a weight average molecular weight (Mw), measured by aqueous gel permeation chromatography (GPC) with light scattering detection (SEC-MALLS), in the range of from about 25,000 to about 75,000 Da.

14. The composition according to claim 11, wherein the quaternised acrylic copolymer has an average cationic charge density of from about 0.01 to about 2.8.

15. The composition according to claim 11, wherein the quaternised acrylic copolymer is derived from:
a. cationic monomer units selected from: 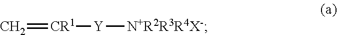
wherein:
each R¹ are independently selected from a hydrogen or a methyl;
each R² is independently selected from a C1 to C4 alkyl(ene);
each R³, R⁴ are independently selected from a C1 to C4 alkyl;
each Y is a linking group independently selected from: CO—NR⁵—(CH₂)ₙ, CO—O—(CH₂)ₙ, or (CH₂)ₙ,
wherein:
each R⁵ is independently selected from: hydrogen or methyl,
n is an average of from about 1 to about 4; and
X⁻ is a suitable counterion; and
b. ethylenically unsaturated monomer units.

16. The composition according to claim 11, wherein in the quaternised acrylic copolymer:
a. cationic monomer unit is selected from: 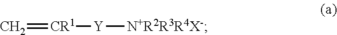
wherein:
each R¹ is methyl;
each R² is CH₂CH═CH₂ or methyl;
each R³, R⁴ are independently selected from a C1 to C3 alkyl;
each Y is a linking group independently selected from: CO—NR⁵—(CH₂)ₙ, or (CH₂)ₙ,
wherein:
each R⁵ is hydrogen,
n is an average of from about 1 or about 3.

17. The composition according to claim 16, wherein the cationic monomer unit is selected from the group consisting of: acrylamidopropyl trimethylammonium chloride (APTAC), diallyl dimethyl ammonium chloride (DADMAC); acryloyloxyethyltrimethylammonium chloride (AETAC); methacrylamidopropyltrimethylammonium chloride (MAPTAC); methyloyloxy ethyl trimethyl ammonium chloride (METAC), and mixtures thereof.

18. The composition according to claim 16, wherein the ethylenically unsaturated monomer units are selected from the group consisting of: C3-C8 ethylenically unsaturated acids and/or salts thereof, C3-C8 hydroxyalkyl acrylates, and mixtures thereof.

19. The composition according to claim 11, wherein the anionic surfactant comprises at least about 70%, preferably at least about 85%, more preferably about 100% by weight of the anionic surfactant of the alkyl sulphated anionic surfactant.

20. The composition according to any claim 11, wherein the alkyl sulfated anionic surfactant is free of alkoxylation.
